(19) United States
(12) Patent Application Publication
(10) Pub. No.: US 2026/0179135 A1
(43) Pub. Date: Jun. 25, 2026

(54) INVENTORY ITEM SUGGESTION PLATFORM

(71) Applicant: eBay Inc., San Jose, CA (US)

(72) Inventors: Anton Smirnov, Prague (CZ); Wenjia Xie, Shanghai (CN)

(21) Appl. No.: 18/924,065

(22) Filed: Oct. 23, 2024

(51) Int. Cl. G06Q 30/0601

(52) U.S. Cl. CPC G06Q 30/0631

(57) ABSTRACT

A transaction system selects an individual item from an inventory associated with an online seller in an online e-commerce platform. The transaction system obtains, from a database of the online e-commerce platform, information associated with the individual item. The transaction system processes the information associated with the individual item by one or more large language models (LLMs) and one or more machine learning models to identify a target item that is associated with the individual item and generates a recommendation for presentation to the online seller to expand the inventory associated with the online seller to include the target item.

### BACKGROUND

The subject matter disclosed herein generally relates to a special-purpose machine that includes a system for completing transactions using multiple services, including computerized variants of such special-purpose machines and improvements to such variants, and to the technologies by which such special-purpose machines become improved compared to other special-purpose machines.

### BRIEF SUMMARY

In some aspects, the techniques described herein relate to a system including: one or more hardware processors; and at least one machine-storage medium for storing instructions that, when executed by the one or more hardware processors, cause the one or more hardware processors to perform operations including: selecting an individual item from an inventory associated with an online seller in an online e-commerce platform; obtaining, from a database of the online e-commerce platform, information associated with the individual item; processing the information associated with the individual item by one or more large language models (LLMs) and one or more machine learning models to identify a target item that is associated with the individual item; and generating a recommendation for presentation to the online seller.

In some aspects, the techniques described herein relate to a system, wherein processing the information includes: generating, using at least partially a set of data stored in the database, a set of knowledge graphs (KGs) by the one or more LLMs; processing the set of KGs and data associated with a plurality of items and the online seller to select the target item; and detecting a condition including the individual item being frequently included in transactions associated with a second item of the plurality of items.

In some aspects, the techniques described herein relate to a system, wherein the operations include: in response to detecting the condition, generating the set of KGs including a leaf category expert KG, a user-item transaction KG, and an item aspect expert KG.

In some aspects, the techniques described herein relate to a system, wherein the operations for generating the leaf category expert KG include: identifying an individual category associated with the individual item; generating a prompt with an instruction to identify a plurality of complementary categories in which a set of users are interested in completing transactions for items, wherein the set of users have each previously completed one or more transactions for items in the individual category; and processing the prompt by the one or more LLMs to generate a list of complementary categories.

In some aspects, the techniques described herein relate to a system, wherein the operations include: generating the leaf category expert KG including unidirectional relationships between nodes representing the individual category and the list of complementary categories.

In some aspects, the techniques described herein relate to a system, wherein the operations for generating the item aspect expert KG include: identifying an individual category associated with the individual item; generating a first prompt with a first instruction to identify a set of item aspects that transacting users consider in performing transactions for items associated with the individual category; and processing the first prompt and inventory aspect data associated with the plurality of items by the one or more LLMs to generate a list of item aspects.

In some aspects, the techniques described herein relate to a system, wherein the operations include: generating a second prompt with a second instruction to process each item aspect of the list of item aspects to identify a set of relevant aspects associated with each item aspect in which transacting users are interested in completing transactions for items, the transacting users including a set of users who have previously completed transactions in items in the respective item aspect; and processing the second prompt and the inventory aspect data by the one or more LLMs to generate a list of relevant aspects for each item aspect of the list of item.

In some aspects, the techniques described herein relate to a system, wherein the operations include: generating the item aspect expert KG including relationships between nodes representing the list of relevant aspects for each item aspect of the list of item aspects.

In some aspects, the techniques described herein relate to a system, wherein the operations for generating the user-item transaction KG include: identifying a set of transacting users who previously performed a transaction on the individual item; identifying other items that the set of transacting users performed transactions on within a threshold interval; and generating the user-item transaction KG including relationships between nodes representing the individual item and the other items.

In some aspects, the techniques described herein relate to a system, wherein the operations include: generating user embedding information by processing item embedding information associated with the plurality of items with items in the inventory associated with the online seller.

In some aspects, the techniques described herein relate to a system, wherein the operations include: generating embeddings for each node in the set of KGs based on the item embedding information associated with the plurality of items.

In some aspects, the techniques described herein relate to a system, wherein the operations include: processing a first set of nodes in the leaf category expert KG by a path sampling component to generate a first plurality of meta-path instances; processing a second set of nodes in the user-item transaction KG by the path sampling component to generate a second plurality of meta-path instances; and processing a third set of nodes in the item aspect expert KG by the path sampling component to generate a third plurality of meta-path instances.

In some aspects, the techniques described herein relate to a system, wherein each meta-path instance in the first plurality of meta-path instances includes first, second, third, and fourth nodes connected in sequence, the first node representing a first item associated with a first category represented by the second node in the leaf category expert KG, the third node representing a second category in the leaf category expert KG that is related to the first category, and the fourth node representing a second item associated with the second category.

In some aspects, the techniques described herein relate to a system, wherein each meta-path instance in the second plurality of meta-path instances includes first, second, third, and fourth nodes connected in sequence, the first node representing a first user who performed a transaction for a third item represented by the second node in the user-item transaction KG, and the third node representing a second user who performed a transaction for the third item and who performed a transaction for a fourth item represented by the fourth node.

In some aspects, the techniques described herein relate to a system, wherein each meta-path instance in the third plurality of meta-path instances includes first, second, third, and fourth nodes connected in sequence, the first node representing a first item associated with a first item aspect represented by the second node in the item aspect expert KG, the third node representing a second item aspect in the item aspect expert KG that is related to the first item aspect, and the fourth node representing a second item associated with the second item aspect.

In some aspects, the techniques described herein relate to a system, wherein the operations include: encoding the first plurality of meta-path instances by a path encoding layer of the one or more machine learning models to generate a first path encoding; encoding the second plurality of meta-path instances by the path encoding layer of the one or more machine learning models to generate a second path encoding; encoding the third plurality of meta-path instances by the path encoding layer of the one or more machine learning models to generate a third path encoding; and processing the first path encoding, the second path encoding, and the third path encoding by a self-attention layer of the one or more machine learning models to generate meta-path based context embedding associated with the first path encoding, the second path encoding, and the third path encoding, the self-attention layer trained to weigh importance of different path instances in a same context against each other while capturing dependencies between the path instances.

In some aspects, the techniques described herein relate to a system, wherein the operations include: processing the meta-path based context embedding together with the user embedding information by a cross attention layer of the one or more machine learning models to generate context-based user embedding data; and processing the meta-path based context embedding together with the item embedding information by the cross attention layer of the one or more machine learning models to generate context-based item embedding data.

In some aspects, the techniques described herein relate to a system, wherein the operations include: combining the context-based user embedding data with the context-based item embedding data to generate a unified representation; processing the unified representation by a multi-layer perceptron (MLP) layer of the one or more machine learning models to generate scores that relate the online seller with a subset of items of the plurality of items; and identifying the target item from the subset of items based on the scores that relate the online seller with the subset of items of the plurality of items.

In some aspects, the techniques described herein relate to a method including: selecting, by one or more hardware processors, an individual item from an inventory associated with an online seller in an online e-commerce platform; obtaining, from a database of the online e-commerce platform, information associated with the individual item; processing the information associated with the individual item by one or more LLMs and one or more machine learning models to identify a target item that is associated with the individual item; and generating a recommendation for presentation to the online seller to expand the inventory associated with the online seller to include the target item.

In some aspects, the techniques described herein relate to a machine-storage medium for storing instructions that, when executed by one or more hardware processors, cause the one or more hardware processors to perform operations including: selecting an individual item from an inventory associated with an online seller in an online e-commerce platform; obtaining, from a database of the online e-commerce platform, information associated with the individual item; processing the information associated with the individual item by one or more LLMs and one or more machine learning models to identify a target item that is associated with the individual item; and generating a recommendation for presentation to the online seller to expand the inventory associated with the online seller to include the target item.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 is a diagrammatic representation of a networked environment in which the present disclosure may be deployed, in accordance with some examples.

FIG. 2 is a block diagram illustrating examples of applications that, in one example, are provided as part of a networked system, in accordance with some examples.

FIG. 3 is a block diagram illustrating an inventory item suggestion platform that, in one example, is provided as part of a networked system, in accordance with some examples.

FIG. 4 illustrates a diagram of a leaf category expert KG generation, in accordance with some examples.

FIG. 5 illustrates a diagram of an item aspect expert KG generation, in accordance with some examples.

FIG. 6 illustrates a routine for suggesting items for an inventory, in accordance with some examples.

FIG. 7 is a block diagram illustrating a representative software architecture, which may be used in conjunction with various hardware architectures herein described, in accordance with some examples.

FIG. 8 is a diagrammatic representation of a machine in the form of a computer system within which a set of instructions may be executed for causing the machine to perform any one or more of the methodologies discussed herein, in accordance with some examples.

### DETAILED DESCRIPTION

The description that follows describes systems, methods, techniques, instruction sequences, and computing machine program products that illustrate examples of the present subject matter. In the following description, for purposes of explanation, numerous specific details are set forth in order to provide an understanding of various examples of the present subject matter. It will be evident, however, to those skilled in the art, that examples of the present subject matter may be practiced without some or other of these specific details. Examples merely typify possible variations. Unless explicitly stated otherwise, structures (e.g., structural components, such as modules) are optional and may be combined or subdivided, and operations (e.g., in a procedure, algorithm, or other function) may vary in sequence or be combined or subdivided.

Recommender systems are extensively utilized within the e-commerce sector to assist consumers in discovering complementary products aligned with their interests or to discover unique items that may spark a new purchasing journey. However, the application of recommender systems for inventory providers is not utilized. Within the marketplace economic framework, sellers or inventory providers frequently encounter a scarcity of market trend data, often due to limited resources. Conversely, marketplace platforms amass extensive data from buyers and possess the resources to assess and forecast inventory demands and trends. This disparity in data access is known as information asymmetry, where one party holds more information than the other. This imbalance can result in sellers being reluctant to expand their inventory. By providing sellers with relevant information, the quality and relevance of the inventory listed can be enhanced, and the introduction of new inventory can attract additional buyers to the platform. Sellers often lack market information due to limited resources for market research, which leads to substantial inefficiencies and waste of resources across various industries.

Without precise data on consumer demand, market trends, and product performance, sellers often make suboptimal decisions about their inventory. They may overstock items that have low demand, tying up capital and storage space unnecessarily. Conversely, they might understock popular products, missing out on potential sales and customer satisfaction. This misalignment between supply and demand results in lost revenue opportunities and increased operational costs. The absence of reliable information can lead to the accumulation of obsolete or slow-moving inventory. These items occupy valuable warehouse space and depreciate over time, ultimately requiring markdowns or write-offs. This not only impacts profitability but also creates environmental concerns due to potential waste. Inaccurate forecasting based on limited information can cause ripple effects, leading to overproduction or shortages at various stages of the supply chain. This results in increased transportation costs, rush orders, and potential disruptions in product availability. The lack of data-driven insights hampers a seller's ability to optimize pricing strategies, identify emerging market opportunities, and respond quickly to changing consumer preferences. This information deficit puts sellers at a competitive disadvantage in an increasingly data-driven retail landscape.

The present application describes a novel system that addresses these technical challenges. The disclosed system suggests specific items for adding to a seller's inventory that could expand a seller's inventory, taking into account their preferences, buyer demand, and economic projections. The disclosed techniques integrate various methodologies to deliver optimal item recommendations, such as an expert KG at the leaf category level for complementary suggestions, an expert KG at the aspect level for in-category and subject-related recommendations, and buyer behavior graphs reflecting purchasing behaviors and patterns. The disclosed expert KG is capable of discerning real-world connections in a specific niche category that generic knowledge graphs are not able to identify. The disclosed techniques address market inefficiency arising from information asymmetry between sellers and marketplace providers by introducing a scalable seller recommender system that utilizes the expert KG. Utilizing the expert KG allows for differentiation in listing recommendations based on the nature of the inventory. This differentiation facilitates multiple opportunities for inventory extension while maintaining high seller satisfaction scores. By differentiating types of inventory, item inventory recommendations can be tailored based on seller preferences, offering multiple options that cover a range of possibilities. Complementary item recommendations represent vertical inventory expansion, in-category and subject-related recommendations signify horizontal inventory expansion, and out-of-category recommendations act as cross-industry expansion guardrails due to the marketplace's nature.

Specifically, the disclosed techniques leverage a combination of LLMs with one or more machine learning models to generate unique suggestions or recommendations of items for a seller to include in their inventory. The disclosed techniques select an individual item from an inventory associated with an online seller in an online e-commerce platform. The disclosed techniques obtain, from a database of the online e-commerce platform, information associated with the individual item. The disclosed techniques process the information associated with the individual item by one or more LLMs and one or more machine learning models to identify a target item that is associated with the individual item and generate a recommendation for presentation to the online seller to expand the inventory associated with the online seller to include the target item.

With the advent of LLMs, the disclosed techniques possess the capability to delve deeper into the intrinsic associations within items. This unlocks deeper contextual information underlying people's purchase behaviors. By leveraging LLMs, the disclosed techniques are able to discern the underlying factors contributing to the popularity of specific items in a seller's inventory and establish correlations with other related items to provide expert recommendations for expanding the inventory for a seller. For example, two types of KGs based on the seller's inventory are created using the LLMs: a leaf category KG and an item aspect KG. The leaf category KG is designed to unearth complementary relationships, while the item aspect KG is aimed at unveiling alternative items of buyer interest. Aligned with the user-item graph derived from the user purchase behaviors, three distinct types of graphs are processed by the machine learning models to augment the contextual understanding between the user and item relations and generate one or more item suggestions for a seller to add to their inventory. Meta-paths within each KG can be sampled and employed in path encoding techniques to provide the suggestions by learning the vector representations of the meta-path-based context. In some cases, an attention mechanism (machine learning model) can be integrated into the model to enhance the understanding of how sellers can engage with items across different contexts.

As a result, one or more of the methodologies described herein facilitate solving the technical problem of inventory management presented by conventional methods. As such, one or more of the methodologies described herein may obviate a need for certain efforts or computing resources that otherwise would be involved in managing inventories. As a result, resources used by one or more machines, databases, or devices (e.g., within the environment) may be reduced. Examples of such computing resources include processor cycles, network traffic, memory usage, data storage capacity, power consumption, network bandwidth, and cooling capacity.

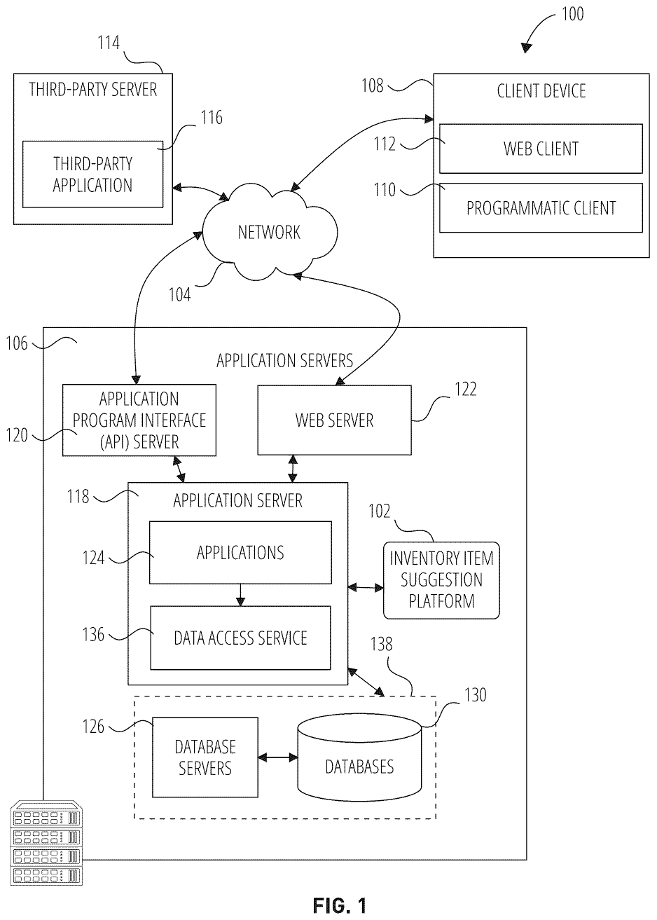

FIG. 1 is a diagrammatic representation of a network environment 100 in which some examples of the present disclosure may be implemented or deployed. One or more application servers 106 provide server-side functionality via a network 104 to a networked user device, in the form of a client device 108. A web client 112 (e.g., a browser) and a programmatic client 110 (e.g., an “app”) are hosted and execute on the web client 112.

An Application Program Interface (API) server 120 and a web server 122 provide respective programmatic and web interfaces to application servers 106. A specific application server 118 hosts an applications 124 and a data access service 136, which includes components, modules and/or applications.

The applications 124 may provide a number of functions and services to users who access the application servers 106. For example, the applications 124 may include a publication application that enables users to publish content (e.g., product item information) on a hosted web page. While the applications 124 is shown in FIG. 1 to be part of the application servers 106, it will be appreciated that, in alternative examples, the applications 124 may be separate and distinct from the application server 118. The applications 124 can also provide buyers to purchase items from an online electronic commerce platform where users can buy and sell physical (tangible) and/or intangible items.

The data access service 136 coordinates requests from the applications 124 to access services provided by inventory item suggestion platform 102 and to access data stored in one or more cache nodes and/or databases 130 of the data access layer 138. For example, the data access service 136 coordinates transaction requests from the applications 124 across distributed database servers of the inventory item suggestion platform 102. The inventory item suggestion platform 102 can enable sellers to manage their inventories by suggesting items to add or include in their inventories.

Further, while the network environment 100 shown in FIG. 1 employs a client-server architecture, the examples are, of course, not limited to such an architecture, and could equally well find application in a distributed, or peer-to-peer, architecture system. The applications 124 could also be implemented as a standalone software program, which do not necessarily have networking capabilities.

The web client 112 accesses the applications 124 via the web interface supported by the web server 122. Similarly, the programmatic client 110 accesses the various services, microservices, and functions provided by the applications 124 via the programmatic interface provided by the Application Program Interface (API) server 120. In one example, the programmatic client 110 may, for example, be a seller application (e.g., eBay Application developed by eBay Inc., of San Jose, California) to enable sellers to author and manage listings on the network environment 100 in an offline manner, and to perform batch-mode communications between the programmatic client 110 and the application servers 106. In one example, the programmatic client 110 may, for example, be a buyer (purchaser) application (e.g., eBay Application developed by eBay Inc., of San Jose, California) to enable buyers to search available listings for items on the network environment 100 in an online manner, to select items to purchase, and to perform batch-mode communications between the programmatic client 110 and the application servers 106.

FIG. 1 also illustrates a third-party application 116 executing on a third-party server 114 as having programmatic access to the application servers 106 via the programmatic interface provided by the Application Program Interface (API) server 120. For example, the third-party application 116 may, utilizing information retrieved from the application server 118, support one or more features or functions on a website hosted by a third party. The third-party website may, for example, provide one or more promotional, marketplace, or payment functions that are supported by the relevant applications of the application servers 106.

Any of the systems or machines (e.g., databases, devices, servers) shown in, or associated with, FIG. 1 may be implemented in a special-purpose (e.g., specialized or otherwise non-generic) computer that has been modified (e.g., configured or programmed by software, such as one or more software modules of an application, operating system, firmware, middleware, or other program) to perform one or more of the functions described herein for that system or machine. For example, a special-purpose computer system able to implement any one or more of the methodologies described herein is discussed below, and such a special-purpose computer may accordingly be a means for performing any one or more of the methodologies discussed herein. Within the technical field of such special-purpose computers, a special-purpose computer that has been modified by the structures discussed herein to perform the functions discussed herein is technically improved compared to other special-purpose computers that lack the structures discussed herein or are otherwise unable to perform the functions discussed herein. Accordingly, a special-purpose machine configured according to the systems and methods discussed herein provides an improvement to the technology of similar special-purpose machines.

Moreover, any two or more of the systems or machines illustrated in FIG. 1 may be combined into a single system or machine, and the functions described herein for any single system or machine may be subdivided among multiple systems or machines. Additionally, any number and types of client device 108 may be embodied within the network environment 100. Furthermore, some components or functions of the network environment 100 may be combined or located elsewhere in the network environment 100. For example, some of the functions of the client device 108 may be embodied at the application server 118.

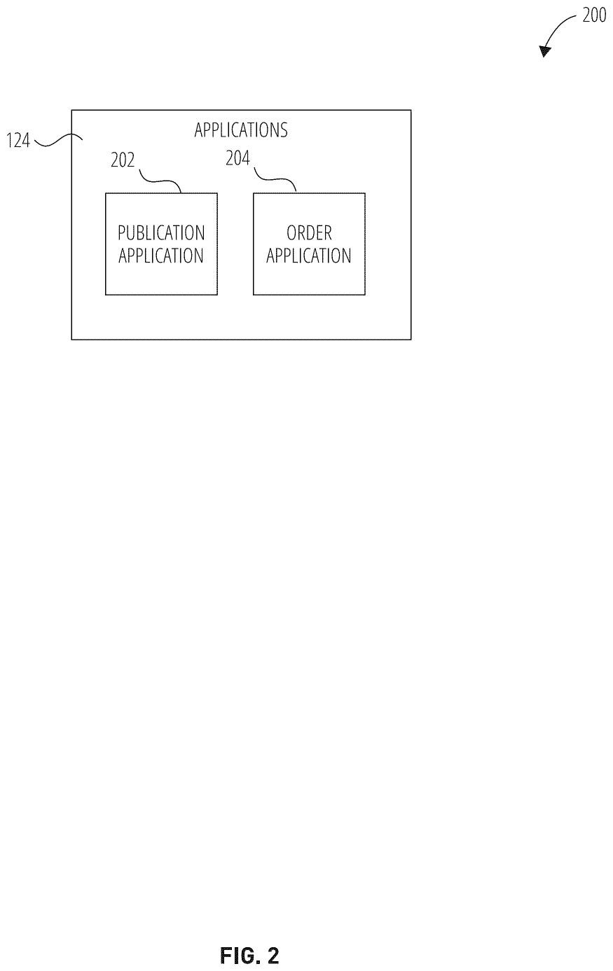

FIG. 2 is a block diagram 200 illustrating the applications 124 that, in one example, are provided as part of the network environment 100. The applications 124 may be hosted on dedicated or shared server machines (not shown) that are communicatively coupled to enable communications between or among server machines. The applications 124 themselves are communicatively coupled (e.g., via appropriate interfaces) to each other and to various data sources, so as to allow information to be passed between or among the applications 124 or so as to allow the applications 124 to share and access common data. The applications 124 may furthermore access one or more databases 130 via the database servers 126.

The application server 118 may provide a number of publishing, listing, and price-setting mechanisms whereby a seller may list (or publish information concerning) goods or services for sale, a buyer can express interest in or indicate a desire to purchase such goods or services, and a price can be set for a transaction pertaining to the goods or services. To this end, the applications 124 is shown to include at least one publication application 202 and one or more order application 204.

In some cases, the applications 124 can provide a graphical user interface (GUI) to a seller. The GUI can include an identification or list of items included in an inventory of the seller. The inventory item suggestion platform 102 can identify one or more items in the databases 130 that is not currently included in the inventory of the seller, such as using the methodologies discussed above and below. In response, the inventory item suggestion platform 102 can instruct the GUI to present an identifier and automatically generate a listing for the identified one or more items. The seller can interact with the GUI to add the one or more items to their inventory and to publish the listing for the one or more items as part of the seller's inventory, such as in response to selection of an add item option presented in the GUI.

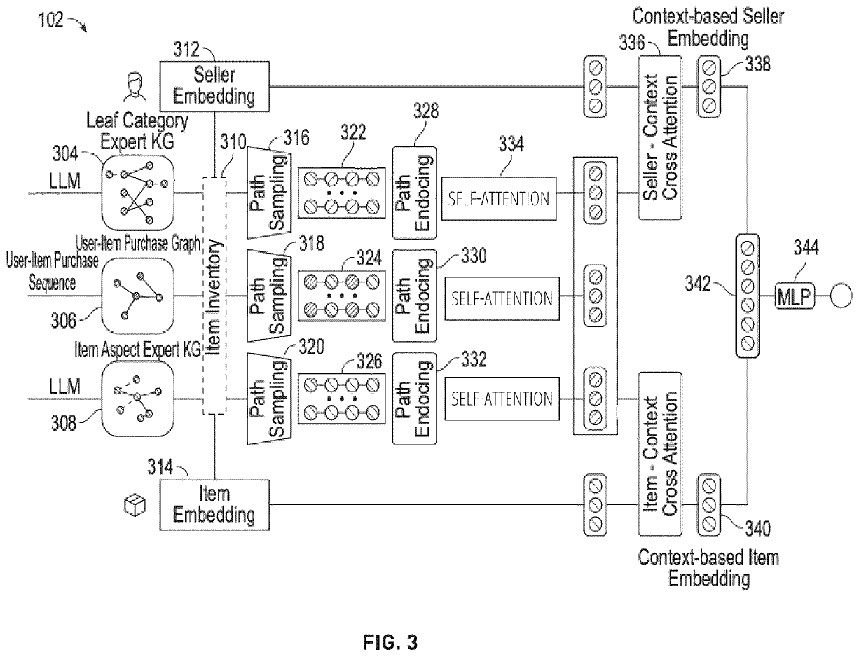

FIG. 3 is a block diagram illustrating an inventory item suggestion platform 102 that, in one example, is provided as part of the network environment 100. The inventory item suggestion platform 102 include many different components. For example, the inventory item suggestion platform 102 includes a leaf category expert KG 304, a user-item transaction KG 306, an item aspect expert KG 308, an item inventory 310 (e.g., an inventory of a seller), a first path sampling component 316, a second path sampling component 318, a third path sampling component 320, a first path encoding 328, a second path encoding 330, a third path encoding 332, a cross attention layer 336, a MLP layer 344, and any other suitable component or device.

In some examples, the inventory item suggestion platform 102 accesses an item inventory 310 of a particular seller. The seller can be associated with a seller embedding 312. The inventory item suggestion platform 102 can also access or select a particular item from the item inventory 310 of the seller and generate an item embedding 314 for the particular item. The embeddings for the seller and the item can be generated or accessed from the databases 130. In some cases, a seller using the client device 108 and the applications 124 can select an option to request an inventory item suggestion. In response, the inventory item suggestion platform 102 can generate a suggestion of an item to include in the seller's inventory. In some cases, the inventory item suggestion platform 102 can identify a popular item in the seller's inventory or can receive input that selects a particular item in the seller's inventory. Using the identified or selected item, the inventory item suggestion platform 102 obtains the item embedding 314 and uses the item embedding 314 to generate a suggestion for one or more complementary items to add or include in the seller's inventory. In some examples, the suggestion is triggered in response to a condition, such as in response to determining that a particular item is in the seller's inventory that is frequently purchased together with one or more other items by buyers or is a trending or popular item.

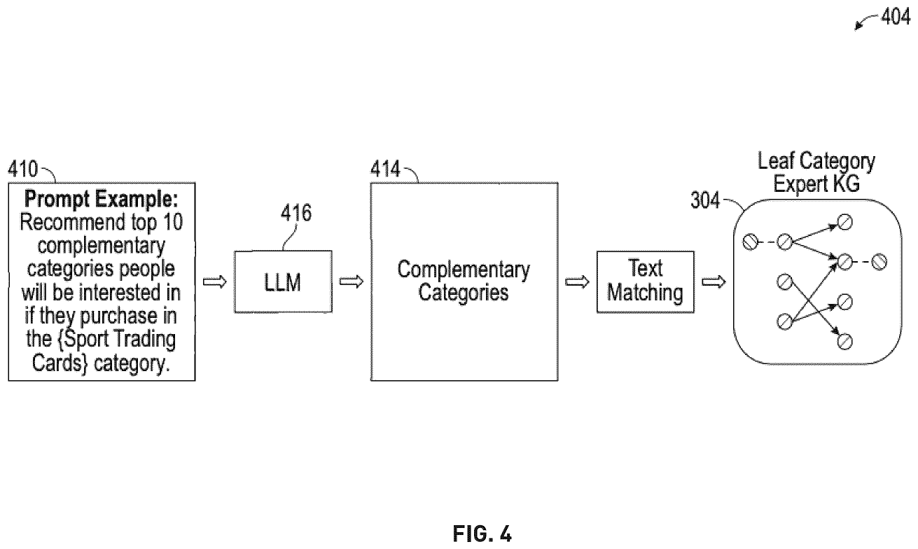

In some cases, the inventory item suggestion platform 102 generates three graphs in the process of finding the one or more complementary items to suggest to the seller. The three graphs include the leaf category expert KG 304, user-item transaction KG 306, and item aspect expert KG 308. The leaf category expert KG 304 can be generated by one or more LLMs, such as LLM 416 (FIG. 4) and can identify cross-category complementary relationships between a category of the selected item and other categories.

FIG. 4 illustrates a diagram 404 of a leaf category expert KG 304 generation, according to some examples. Specifically, as shown in the diagram 404, a prompt 410 can be generated or defined (automatically or manually by an operator of the network environment 100). The inventory item suggestion platform 102 can retrieve an individual category associated with the selected item from the seller's inventory, such as based on the item embedding 314.

The prompt 410 can include an instruction to identify a plurality of complementary categories in which a set of users are interested in completing transactions for items. The set of users may have each previously completed one or more transactions for items in the individual category. For example, the prompt 410 can request an LLM 416 to recommend a set of ten (or any other suitable quantity) complementary categories in which buyers are interested in purchasing items if they purchase an item that is associated with the individual category. The prompt 410 can generally be defined as: “Recommend top {M} complementary categories people will be interested in if they purchase in the {Category},” where M is the quantity of categories desired, and Category represents the category of the selected item from the seller's current inventory.

The prompt 410 is provided to the LLM 416 (e.g., one or more LLMs) and is processed by the LLM 416 to generate a list of complementary categories 414 associated with the individual category. For example, in the case of Sport Trading Cards, the LLM 416 discerns that buyers interested in purchasing trading cards (e.g., the individual category can be trading cards) may also express interest in acquiring items in other categories, such as trading card protectors or other sports card memorabilia. The leaf category relationship can be unidirectional, signifying that category B may not necessarily complement category A if A complements B. Consequently, the LLM 416 output is mapped with the leaf categories as entities to construct the leaf category expert KG 304. Specifically, based on the complementary categories 414, the leaf category expert KG 304 is generated based on unidirectional relationships between nodes representing the individual category (e.g., the trading cards category) and the list of complementary categories (e.g., provided by the LLM 416, such as trading card protectors and other sports card memorabilia). While the disclosed examples relate to sports trading cards, similar techniques are applicable to any other field or category of items.

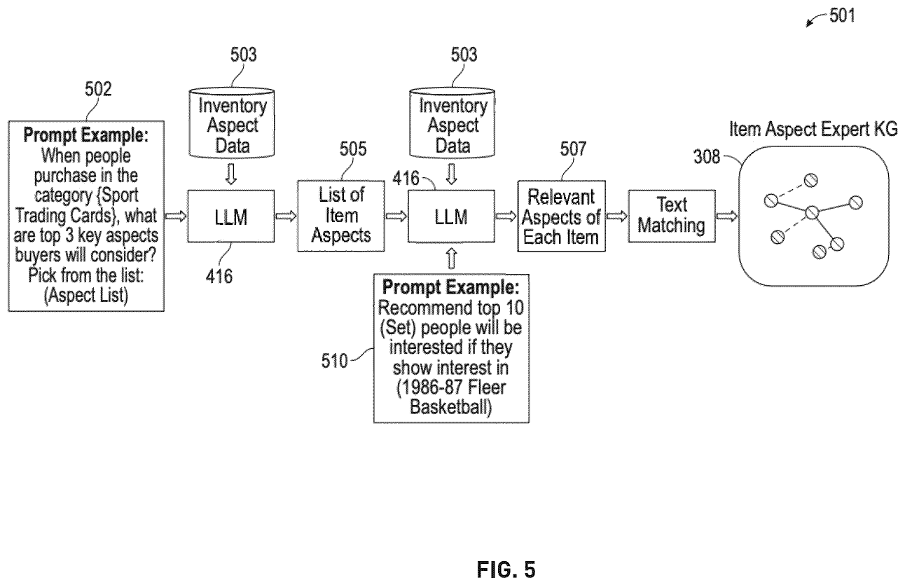

Another KG that is utilized by the inventory item suggestion platform 102 is the item aspect expert KG 308, shown in diagram 501 of FIG. 5. The item aspect expert KG 308 extracts substitutive relationships among items. Namely, the LLM 416 is utilized to produce item relationships. The output of the LLM 416 (based on a set of prompts) can be converted into a structured data format. The construction process can be viewed as the transformation of expert knowledge into structured data.

The item inventory 310 is accessed and used to identify the top selling items and to extract their associated item aspect types. These aspect types can be denoted as A={a₁, a₂, . . . aₙ}, along with the corresponding aspect values V={v1^{a1}, v2^{a2}, . . . vn^{an}}. The item aspect expert KG 308 is then constructed using chain-of-thought approach, shown in the diagram 501. In the first step, a first prompt 502 is constructed to utilize the LLM 416 to pick top aspects that can influence users purchase decisions from the inventory aspect data 503. The prompt can be defined as: “When people purchase in the {category}, what are the top {N} key aspects people will consider? Pick from the list {A}. Output format: One aspect one line, without any explanations.” For instance, in the category Sport Trading Cards, the LLM 416 may prioritize aspects such as player, set, and seasons as central factors in its decision-making process.

For example, the inventory item suggestion platform 102 can obtain the individual category of the selected item from the seller's inventory. The inventory item suggestion platform 102 can then generate the first prompt 502 with a first instruction for the LLM 416 to identify a set of item aspects 505 transacting users (e.g., buyers) consider in performing transactions (e.g., purchases) for items associated with the individual category. The LLM 416 processes the first prompt 502 and inventory aspect data 503 (e.g., obtained from the databases 130) to generate a list of item aspects 505.

Subsequently, the inventory item suggestion platform 102 can generate a second prompt 510. The second prompt 510 includes a second instruction for the LLM 416 to process each item aspect of the list of item aspects 505 to identify a set of relevant aspects of each item 507 of each item in the list of item aspects 505 in which transacting users are interested in completing transactions for items. The transacting users can include a set of users who have previously completed transactions (e.g., purchases) in items in the respective item aspect. For example, for each selected aspect ai, the inventory item suggestion platform 102 constructs a prompt to retrieve top K most relevant aspect values {vj^{ai}} in each aspect dimension. The second prompt 510 can be defined as: “Provide recommendations for the top {K} associated {aᵢ} buyer will be interested if they show purchase intent in {v^{a}i}”. In line with the Sport Trading Cards illustration, if the best-selling cards originate from the Set: 1986-87 FLEER Basketball, the LLM 416 may infer that buyers are also interested in other significant milestones of Michael Jordan, like the Set: 1984-85 Star Company Basketball; thus this edge between two sets is generated.

Based on the output of the LLM 416, the inventory item suggestion platform 102 can get the pseudo of the entities and their edges in the item aspect expert KG 308. These pseudo entities can then be mapped with the item aspect data using the text matching techniques based on text embeddings. Namely, the output of the LLM 416 based on the second prompt 510 can be used to generate the item aspect expert KG 308 that includes or defines relationships between nodes representing the list of relevant aspects for each item aspect of the list of item aspects 505.

Referring back to FIG. 3, the inventory item suggestion platform 102 can also generate the user-item transaction KG 306. To do so, the inventory item suggestion platform 102 can identify a set of transacting users (e.g., buyers) who previously performed a transaction (e.g., a purchase transaction) on the individual item (e.g., the selected item from the seller's inventory) from other sellers (e.g., other users). For example, the inventory item suggestion platform 102 can access the databases 130 to search for the selected item from the seller's inventory. The inventory item suggestion platform 102 can then identify other sellers that also include the same item as the selected item in their inventory. The inventory item suggestion platform 102 can then generate a list of buyers who purchase the selected item. The inventory item suggestion platform 102 can then identify other items that the buyers purchased within a threshold period of time or together with the selected item from the other sellers. The inventory item suggestion platform 102 generates the user-item transaction KG 306 that includes relationships between nodes representing the individual item and the other items. Namely, the user-item transaction KG 306 can generate a node for the selected item and connect that node to other nodes that represent the other items that the buyers purchased together or within a threshold period of time of purchasing the selected item. This graph optimizes the co-occurrence probability among items.

The inventory item suggestion platform 102 applies the first path sampling component 316 to the item inventory 310, the leaf category expert KG 304, the user-item transaction KG 306, and/or the item aspect expert KG 308 to generate the first plurality of meta-path instances 322. Specifically, the first path sampling component 316 processes a first set of nodes in the leaf category expert KG 304 to generate a first plurality of meta-path instances 322. Intuitively, if the embedding of the next node and the current node is similar, the path to the next node is more likely to be connected. Therefore, according to this assumption, the first path sampling component 316 uses a method based on adjacent nodes'similarity to sample the next node along the path in the leaf category expert KG 304. Specifically, for each specified meta-path schema, the first path sampling component 316 measures the priority degree by calculating the similarity between the current node and candidate out-going nodes. Such a priority score directly reflects the association degree between two nodes. Through this approach, the first path sampling component 316 samples and obtains a few meta-path instances and includes such instances in the first plurality of meta-path instances 322 for each leaf-category pair and aspect pair to participate in the recommendation model training. In some cases, a first meta-path instance of the first plurality of meta-path instances 322 includes first, second, third, and fourth nodes connected in sequence. The first node represents a first item associated with a first category represented by the second node in the leaf category expert KG 304. The third node represents a second category in the leaf category expert KG 304 that is related to the first category. The fourth node represents a second item associated with the second category. Nodes in other first plurality of meta-path instances 322 are similarly connected representing other items/aspects/attributes.

The inventory item suggestion platform 102 applies the second path sampling component 318 to the item inventory 310, the leaf category expert KG 304, the user-item transaction KG 306, and/or the item aspect expert KG 308 to generate a second plurality of meta-path instances 324. Specifically, the second path sampling component 318 processes a second set of nodes in the user-item transaction KG 306 to generate the second plurality of meta-path instances 324. Intuitively, if the embedding of the next node and the current node is similar, the path to the next node is more likely to be connected. Therefore, according to this assumption, the second path sampling component 318 uses a method based on adjacent nodes'similarity to sample the next node along the path in the user-item transaction KG 306. Specifically, for each specified meta-path schema, the second path sampling component 318 measures the priority degree by calculating the similarity between the current node and candidate out-going nodes. Such a priority score directly reflects the association degree between two nodes. Through this approach, the second path sampling component 318 samples and obtains a few meta-path instances and includes such instances in the second plurality of meta-path instances 324. In some cases, a first meta-path instance of the second plurality of meta-path instances 324 includes first, second, third, and fourth nodes connected in sequence. The first node represents a first user (buyer) who performed a transaction (purchase) for a third item represented by the second node in the user-item transaction KG 306. The third node represents a second user (buyer) who performed a transaction (purchase) for the third item and who performed a transaction (purchase) for a fourth item represented by the fourth node. Nodes in other second plurality of meta-path instances 324 are similarly connected representing other items/aspects/attributes.

The inventory item suggestion platform 102 applies the third path sampling component 320 to the item inventory 310, the leaf category expert KG 304, the user-item transaction KG 306, and/or the item aspect expert KG 308 to generate a third plurality of meta-path instances 326. Specifically, the third path sampling component 320 processes a third set of nodes in the item aspect expert KG 308 to generate the third plurality of meta-path instances 326. Intuitively, if the embedding of the next node and the current node is similar, the path to the next node is more likely to be connected. Therefore, according to this assumption, the third path sampling component 320 uses a method based on adjacent nodes'similarity to sample the next node along the path in the item aspect expert KG 308. Specifically, for each specified meta-path schema, the third path sampling component 320 measures the priority degree by calculating the similarity between the current node and candidate out-going nodes. Such a priority score directly reflects the association degree between two nodes. Through this approach, the third path sampling component 320 samples and obtains a few meta-path instances and includes such instances in the third plurality of meta-path instances 326. In some cases, a first meta-path instance of the third plurality of meta-path instances 326 includes first, second, third, and fourth nodes connected in sequence. The first node represents a first item associated with a first item aspect represented by the second node in the item aspect expert KG 308. The third node represents a second item aspect in the item aspect expert KG 308 that is related to the first item aspect. The fourth node represents a second item associated with the second item aspect. Nodes in other third plurality of meta-path instances 326 are similarly connected representing other items/aspects/attributes.

The inventory item suggestion platform 102 can perform first path encoding 328, second path encoding 330, and third path encoding 332 for each of the first plurality of meta-path instances 322, second plurality of meta-path instances 324, and third plurality of meta-path instances 326, respectively. Namely, the first path encoding 328 can encode the first plurality of meta-path instances 322 using a path encoding layer of the one or more machine learning models. The second path encoding 330 can encode the second plurality of meta-path instances 324 using a path encoding layer of the one or more machine learning models. The third path encoding 332 can encode the third plurality of meta-path instances 326 using a path encoding layer of the one or more machine learning models. Specifically, to incorporate the meta-path based context, the inventory item suggestion platform 102 learns the vector representation of the path instances. Specifically, the information underlying the aspect, item, and leaf category is conveyed through text, e.g., the aspect value, item title, and the corresponding leaf category name. To measure the text similarity, the inventory item suggestion platform 102 can utilize pre-trained eBert embeddings to encode the entity including leaf category, item, and aspect along the path instance. The path instance embedding is then obtained using a convolutional neural network (CNN) as follows: hp=CNN({Xp}; Θ), where Xp denotes the matrix of the path instance Θ and denotes all the related parameters in CNNs.

After getting the embedding of the paths instances sampled from the LLM based knowledge graph and purchase behaviors based user-item graphs, the inventory item suggestion platform 102 obtains the meta-based context embedding through the self-attention mechanism (e.g., self-attention layer 334) of the machine learning models. The self-attention mechanism allows the model to weigh the importance of different path instances in the same context against each other, capturing dependencies between them. Compared to a simple pooling method to aggregate the path embedding into context embedding, the self-attention mechanism is better at capturing complex information as the context. For example, a customer may buy a 1992 UPPER DECK Magic Johnson card along with 1992 Skybox USA Basketball #545 Charles Barkley because of multiple reasons: 1) Two cards are from different players, but both featuring Dream Team during the 1992 Olympics in Barcelona. 2) These two cards both demonstrate the variety of parallels available to collectors. With self-attention, this information can be well captured and mixed with importance in the context.

In detail, the meta-path based context embedding can be obtained through Equation 3: Attention(Qφ, Kφ, Vφ)=Softmax(√d) Vφ, MultiHead(Qφ, Kφ, Vφ)=Concat(head1, . . . , headm)WO, where headi is Attention(WiQQφ, WiKKφ, WiV Vφ)x. Query Q, key K and value V are all from path embedding associated with path φ, and W is the weight; dk is the dimensionality; and Concat(·) is the concatenation operation.

The output of the self-attention layer 334 is then provided to the cross-attention layer 336. Given the context embedding including leaf category meta-path, user-item meta-path, and item aspect meta-path, the inventory item suggestion platform 102 is able to incorporate this context embedding with the seller embedding 312 hs and the item embedding 314 hi through a cross-attention mechanism (e.g., cross attention layer 336 of the machine learning model). With cross-attention, it allows the machine learning model to attend to relevant meta-path content while updating the seller and item embedding. Similar to the self-attention mentioned above, the cross-attention can also be obtained with Equation 3. The query Q corresponds to the seller embedding or the item embedding, contingent upon whether it pertains to seller-context or item-context cross attention, respectively. Key K, value V are the path context embedding obtained from self-attention. The inventory item suggestion platform 102 can annotate the updated seller embeddings as h\tilde{s} and updated item s embeddings as hĩ. Namely, the cross-attention layer 336 can produce a context-based user embedding 338 and a context-based item embedding 340.

The inventory item suggestion platform 102 combines the context-based user embedding data (e.g., the context-based user embeddings 338) with the context-based item embedding data (e.g., the context-based item embedding 340) to generate a unified representation (e.g., combined context-based user and item embedding 342). Ultimately, based on the item inventory of a seller, the inventory item suggestion platform 102 applies graphs generated by LLM 416 and encodes this expert knowledge as context embeddings to update seller and item representations. The inventory item suggestion platform 102 concatenates them into a unified representation of the interaction as follows: h \tilde{s},i=[h\tilde{s}; hĩ], where [;] means vector concatenation. Here h\tilde{s} and hĩ denote the updated embeddings of seller s and item i after si cross-attention, and h\tilde{s} encodes the information of an interaction from the seller and item given the context of s, i corresponding meta-path. The inventory item suggestion platform 102 then applies an MLP layer on this vector representation to get the final score between the seller and the item i: r_s,i=MLP(h\tilde{s},i), where the MLP contains a two-hidden-layer neural network with a rectified linear unit (ReLU) function as the activation function and sigmoid function as the output layer. During the training phase, the inventory item suggestion platform 102 learns the parameters of the model using negative sampling. The loss function is calculated as: l_s,i=−logr_s,i−Ej˜Pneg [log(1−r_s,i)], and negative samples are drawn from the noise distribution Pneg, which is a uniform distribution.

The combined context-based user and item embedding 342 is processed by the MLP layer 344 of the one or more machine learning models to generate scores that relate the online seller with a subset of items of the plurality of items in the databases 130. The inventory item suggestion platform 102 can identify the target item to recommend to the seller from the subset of items based on the scores that relate the online seller with the subset of items of the plurality of items.

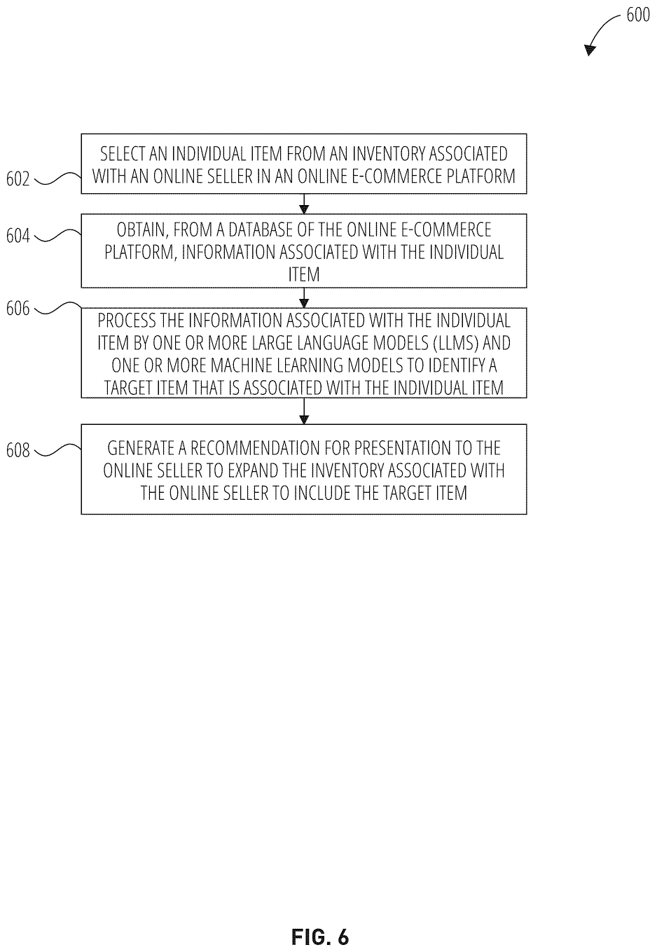

FIG. 6 illustrates a routine 600 (e.g., method or process) in accordance with some examples. The operations discussed in connection with FIG. 6 can be performed sequentially, in parallel, and in any suitable order.

The operations discussed in FIG. 6 can be performed by the inventory item suggestion platform 102. In operation 602, the inventory item suggestion platform 102 selects an individual item from an inventory associated with an online seller in an online e-commerce platform, as discussed above.

In operation 604, the inventory item suggestion platform 102 obtains, from the database servers 126 of the online e-commerce platform (e.g., network environment 100), information associated with the individual item, as discussed above.

In operation 606, the inventory item suggestion platform 102 processes the information associated with the individual item by one or more large language models (LLMs) (e.g., LLM 416) and one or more machine learning models (e.g., self-attention layer 334 and/or multi-layer perceptron layer 344) to identify a target item that is associated with the individual item, as discussed above.

In operation 608, the inventory item suggestion platform 102 generates a recommendation for presentation to the online seller (e.g., via the client device 108) to expand the inventory associated with the online seller to include the target item, as discussed above.

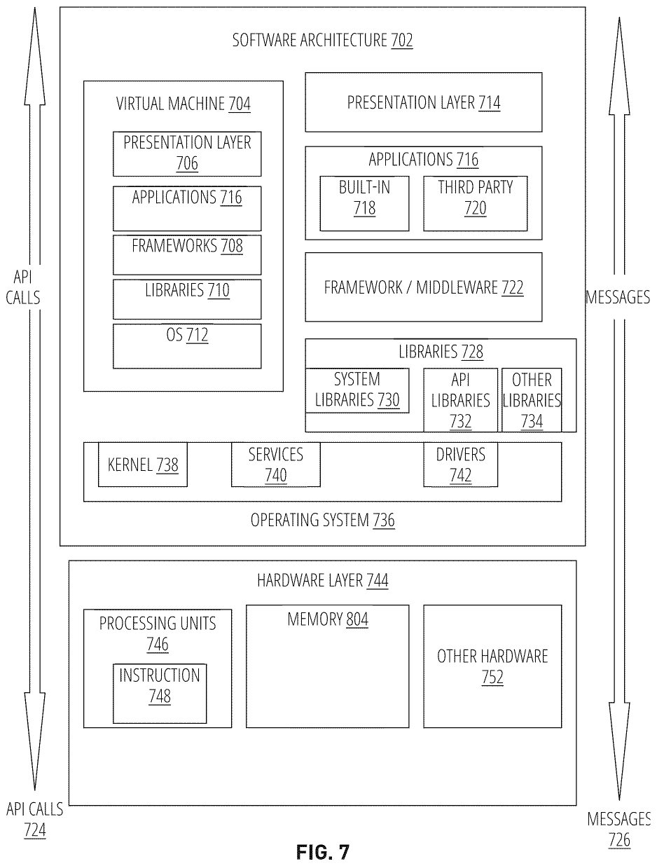

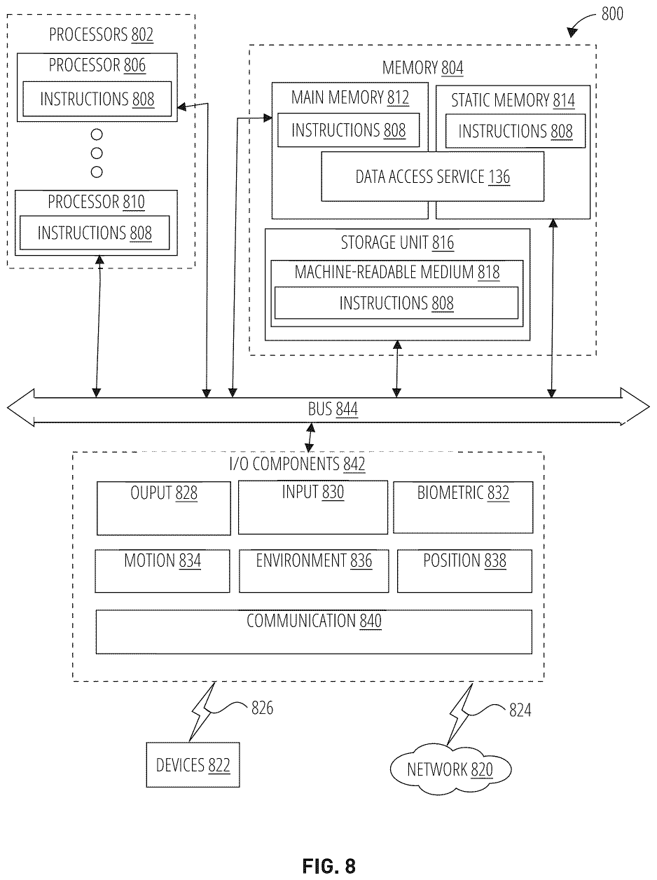

FIG. 7 is a block diagram illustrating an example of a software architecture 702 that may be installed on a machine, according to some examples. FIG. 7 is merely a non-limiting example of a software architecture, and it will be appreciated that many other architectures may be implemented to facilitate the functionality described herein. The software architecture 702 may be executing on hardware such as a machine 800 of FIG. 8 that includes, among other things, processors 810, memory 804, and I/O components 842. A representative hardware layer 744 is illustrated and can represent, for example, the machine 800 of FIG. 8. The representative hardware layer 744 comprises one or more processing units 746 having associated executable instructions 748. The executable instructions 748 represent the executable instructions of the software architecture 702. The hardware layer 744 also includes memory 804, which also have the executable instructions 748. The hardware layer 744 may also comprise other hardware 752, which represents any other hardware of the hardware layer 744, such as the other hardware illustrated as part of the machine 800.

The instructions 748 may be transmitted or received over the network using a transmission medium via a network interface device (e.g., a network interface component included in the communication components 840) and utilizing any one of a number of well-known transfer protocols (e.g., hypertext transfer protocol (HTTP)). Similarly, the instructions 748 may be transmitted or received using a transmission medium via the coupling (e.g., a peer-to-peer coupling) to the devices. The terms “transmission medium” and “signal medium” mean the same thing and may be used interchangeably in this disclosure. The terms “transmission medium” and “signal medium” shall be taken to include any intangible medium that is capable of storing, encoding, or carrying the instructions 748 for execution by the machine 800, and include digital or analog communications signals or other intangible media to facilitate communication of such software. Hence, the terms “transmission medium” and “signal medium” shall be taken to include any form of modulated data signal, carrier wave, and so forth. The term “modulated data signal” means a signal that has one or more of its characteristics set or changed in such a manner as to encode information in the signal.

The terms “machine-readable medium,” “computer-readable medium,” and “device-readable medium” mean the same thing and may be used interchangeably in this disclosure. The terms are defined to include both machine-storage media and transmission media. Thus, the terms include both storage devices/media and carrier waves/modulated data signals.

As used herein, the terms “machine-storage medium,” “device-storage medium,” and “computer-storage medium” mean the same thing and may be used interchangeably in this disclosure. The terms refer to a single or multiple storage devices and/or media (e.g., a centralized or distributed database, and/or associated caches and servers) that store executable instructions and/or data. The terms shall accordingly be taken to include, but not be limited to, solid-state memories, and optical and magnetic media, including memory internal or external to processors. Specific examples of machine-storage media, computer-storage media, and/or device-storage media include non-volatile memory, including by way of example semiconductor memory devices, e.g., erasable programmable read-only memory (EPROM), electrically erasable programmable read-only memory (EEPROM), field-programmable gate arrays (FPGAs), and flash memory devices; magnetic disks such as internal hard disks and removable disks; magneto-optical disks; and CD-ROM and DVD-ROM disks. The terms “machine-storage medium,” “computer-storage medium,” and “device-storage medium” are non-transitory computer-readable media and specifically exclude carrier waves, modulated data signals, and other such media, at least some of which are covered under the term “signal medium.”

In the example architecture of FIG. 7, the software architecture 702 may be conceptualized as a stack of layers, where each layer provides particular functionality. For example, the software architecture 702 may include layers such as an operating system 736, libraries 728, framework/middleware 722, applications 716, and a presentation layer 714. Operationally, the applications 716 or other components within the layers may invoke API calls API calls 724 through the software stack and receive a response, returned values, and so forth (illustrated as messages 726) in response to the API calls 724. The layers illustrated are representative in nature, and not all software architectures have all layers. For example, some mobile or special-purpose operating systems may not provide a framework/middleware 722 layer, while others may provide such a layer. Other software architectures may include additional or different layers.

The operating system 736 may manage hardware resources and provide common services. The operating system 736 may include, for example, a kernel 738, services 740, and drivers 742. The kernel 738 may act as an abstraction layer between the hardware and the other software layers. For example, the kernel 738 may be responsible for memory management, processor management (e.g., scheduling), component management, networking, security settings, and so on. The services 740 may provide other common services for the other software layers. The drivers 742 may be responsible for controlling or interfacing with the underlying hardware. For instance, the drivers 742 may include display drivers, camera drivers, Bluetooth® drivers, flash memory drivers, serial communication drivers (e.g., Universal Serial Bus (USB) drivers), Wi-Fi® drivers, audio drivers, power management drivers, and so forth depending on the hardware configuration.

The libraries 728 may provide a common infrastructure that may be utilized by the applications 716 and/or other components and/or layers. The libraries 728 typically provide functionality that allows other software modules to perform tasks in an easier fashion than by interfacing directly with the underlying operating system 736 functionality (e.g., kernel 738, services 740, or drivers 742). The libraries 728 may include system libraries 730 (e.g., C standard library) that may provide functions such as memory allocation functions, string manipulation functions, mathematic functions, and the like. In addition, the libraries 728 may include API libraries 732 such as media libraries (e.g., libraries to support presentation and manipulation of various media formats such as MPEG4, H.264, MP3, AAC, AMR, JPG, and PNG), graphics libraries (e.g., an OpenGL framework that may be used to render 2D and 3D graphic content on a display), database libraries (e.g., SQLite that may provide various relational database functions), web libraries (e.g., WebKit that may provide web browsing functionality), and the like. The libraries 728 may also include a wide variety of other libraries 734 to provide many other APIs to the applications 716 and other software components/modules.

The frameworks/middleware 722 (also sometimes referred to as middleware) may provide a higher-level common infrastructure that may be utilized by the applications 716 or other software components/modules. For example, the frameworks/middleware 722 may provide various graphical user interface functions, high-level resource management, high-level location services, and so forth. The frameworks/middleware 722 may provide a broad spectrum of other APIs that may be utilized by the applications 716 and/or other software components/modules, some of which may be specific to a particular operating system or platform.

The applications 716 include built-in applications 718 and/or third-party applications 720. Examples of representative built-in applications 718 may include, but are not limited to, a home application, a contacts application, a browser application, a book reader application, a location application, a media application, a messaging application, or a game application.

The third-party applications 720 may include any of the built-in applications 718, as well as a broad assortment of other applications. In a specific example, the third-party applications 720 (e.g., an application developed using the Android™ or iOS™ software development kit (SDK) by an entity other than the vendor of the particular platform) may be mobile software running on a mobile operating system such as iOS™, Android™, or other mobile operating systems. In this example, the third-party applications 720 may invoke the API calls 724 provided by the mobile operating system such as the operating system 736 to facilitate functionality described herein.

The applications 716 may utilize built-in operating system functions (e.g., kernel 738, services 740, or drivers 742), libraries (e.g., system libraries 730, API libraries 732, and other libraries 734), or framework/middleware 722 to create user interfaces to interact with users of the system. Alternatively, or additionally, in some systems, interactions with a user may occur through a presentation layer, such as the presentation layer 714. In these systems, the application/module “logic” can be separated from the aspects of the application/module that interact with the user.

Some software architectures utilize virtual machines. In the example of FIG. 7, this is illustrated by a virtual machine 704. The virtual machine 704 creates a software environment where applications/modules can execute as if they were executing on a hardware machine (e.g., the machine 800 of FIG. 8). The virtual machine 704 is hosted by a host operating system (e.g., the operating system 736) and typically, although not always, has a virtual machine monitor, which manages the operation of the virtual machine 704 as well as the interface with the host operating system (e.g., the operating system 736). A software architecture executes within the virtual machine 704, such as an operating system 712, libraries 710, frameworks 708, applications 716, or a presentation layer 706. These layers of software architecture executing within the virtual machine 704 can be the same as corresponding layers previously described or may be different.

FIG. 8 is a diagrammatic representation of the machine 800 within which instructions 808 (e.g., software, a program, an application, an applet, an app, or other executable code) for causing the machine 800 to perform any one or more of the methodologies discussed herein may be executed. For example, the instructions 808 may cause the machine 800 to execute any one or more of the methods described herein. The instructions 808 transform the general, non-programmed machine 800 into a particular machine 800 programmed to carry out the described and illustrated functions in the manner described. The machine 800 may operate as a standalone device or may be coupled (e.g., networked) to other machines. In a networked deployment, the machine 800 may operate in the capacity of a server machine or a client machine in a server-client network environment, or as a peer machine in a peer-to-peer (or distributed) network environment. The machine 800 may comprise, but not be limited to, a server computer, a client computer, a personal computer (PC), a tablet computer, a laptop computer, a netbook, a set-top box (STB), a PDA, an entertainment media system, a cellular telephone, a smart phone, a mobile device, a wearable device (e.g., a smart watch), a smart home device (e.g., a smart appliance), other smart devices, a web appliance, a network router, a network switch, a network bridge, or any machine capable of executing the instructions 808, sequentially or otherwise, that specify actions to be taken by the machine 800. Further, while only a single machine 800 is illustrated, the term “machine” shall also be taken to include a collection of machines that individually or jointly execute the instructions 808 to perform any one or more of the methodologies discussed herein.

The machine 800 may include processors 802, memory 804, and I/O components 842, which may be configured to communicate with each other via a bus 844. In an example, the processors 802 (e.g., a Central Processing Unit (CPU), a Reduced Instruction Set Computing (RISC) processor, a Complex Instruction Set Computing (CISC) processor, a Graphics Processing Unit (GPU), a Digital Signal Processor (DSP), an ASIC, a Radio-Frequency Integrated Circuit (RFIC), another processor, or any suitable combination thereof) may include, for example, a processor 806 and a processor 810 that execute the instructions 808. The term “processor” is intended to include multi-core processors that may comprise two or more independent processors (sometimes referred to as “cores”) that may execute instructions contemporaneously. Although FIG. 8 shows multiple processors 802, the machine 800 may include a single processor with a single core, a single processor with multiple cores (e.g., a multi-core processor), multiple processors with a single core, multiple processors with multiples cores, or any combination thereof.

The memory 804 includes a main memory 812, a static memory 814, and a storage unit 816, both accessible to the processors 802 via the bus 844. The main memory 804, the static memory 814, and storage unit 816 store the instructions 808 embodying any one or more of the methodologies or functions described herein. The instructions 808 may also reside, completely or partially, within the main memory 812, within the static memory 814, within machine-readable medium 818 within the storage unit 816, within at least one of the processors 802 (e.g., within the processor's cache memory), or any suitable combination thereof, during execution thereof by the machine 800.

The I/O components 842 may include a wide variety of components to receive input, provide output, produce output, transmit information, exchange information, capture measurements, and so on. The specific I/O components 842 that are included in a particular machine will depend on the type of machine. For example, portable machines such as mobile phones may include a touch input device or other such input mechanisms, while a headless server machine will likely not include such a touch input device. It will be appreciated that the I/O components 842 may include many other components that are not shown in FIG. 8. In various examples, the I/O components 842 may include output components 828 and input components 830. The output components 828 may include visual components (e.g., a display such as a plasma display panel (PDP), a light emitting diode (LED) display, a liquid crystal display (LCD), a projector, or a cathode ray tube (CRT)), acoustic components (e.g., speakers), haptic components (e.g., a vibratory motor, resistance mechanisms), other signal generators, and so forth. The input components 830 may include alphanumeric input components (e.g., a keyboard, a touch screen configured to receive alphanumeric input, a photo-optical keyboard, or other alphanumeric input components), point-based input components (e.g., a mouse, a touchpad, a trackball, a joystick, a motion sensor, or another pointing instrument), tactile input components (e.g., a physical button, a touch screen that provides location and/or force of touches or touch gestures, or other tactile input components), audio input components (e.g., a microphone), and the like.

In further examples, the I/O components 842 may include biometric components 832, motion components 834, environmental components 836, or position components 838, among a wide array of other components. For example, the biometric components 832 include components to detect expressions (e.g., hand expressions, facial expressions, vocal expressions, body gestures, or eye tracking), measure biosignals (e.g., blood pressure, heart rate, body temperature, perspiration, or brain waves), identify a person (e.g., voice identification, retinal identification, facial identification, fingerprint identification, or electroencephalogram-based identification), and the like. The motion components 834 include acceleration sensor components (e.g., accelerometer), gravitation sensor components, rotation sensor components (e.g., gyroscope), and so forth. The environmental components 836 include, for example, illumination sensor components (e.g., photometer), temperature sensor components (e.g., one or more thermometers that detect ambient temperature), humidity sensor components, pressure sensor components (e.g., barometer), acoustic sensor components (e.g., one or more microphones that detect background noise), proximity sensor components (e.g., infrared sensors that detect nearby objects), gas sensors (e.g., gas detection sensors to detection concentrations of hazardous gases for safety or to measure pollutants in the atmosphere), or other components that may provide indications, measurements, or signals corresponding to a surrounding physical environment. The position components 838 include location sensor components (e.g., a GPS receiver component), altitude sensor components (e.g., altimeters or barometers that detect air pressure from which altitude may be derived), orientation sensor components (e.g., magnetometers), and the like.

Communication may be implemented using a wide variety of technologies. The I/O components 842 further include communication components 840 operable to couple the machine 800 to a network 820 or devices 822 via a coupling 824 and a coupling 826, respectively. For example, the communication components 840 may include a network interface component or another suitable device to interface with the network 820. In further examples, the communication components 840 may include wired communication components, wireless communication components, cellular communication components, Near Field Communication (NFC) components, Bluetooth® components (e.g., Bluetooth® Low Energy), Wi-Fi® components, and other communication components to provide communication via other modalities. The devices 822 may be another machine or any of a wide variety of peripheral devices (e.g., a peripheral device coupled via a USB).

Moreover, the communication components 840 may detect identifiers or include components operable to detect identifiers. For example, the communication components 840 may include Radio Frequency Identification (RFID) tag reader components, NFC smart tag detection components, optical reader components (e.g., an optical sensor to detect one-dimensional bar codes such as Universal Product Code (UPC) bar code, multi-dimensional bar codes such as Quick Response (QR) code, Aztec code, Data Matrix, Dataglyph, MaxiCode, PDF417, Ultra Code, UCC RSS-2D bar code, and other optical codes), or acoustic detection components (e.g., microphones to identify tagged audio signals). In addition, a variety of information may be derived via the communication components 840, such as location via Internet Protocol (IP) geolocation, location via Wi-Fi® signal triangulation, location via detecting an NFC beacon signal that may indicate a particular location, and so forth.

The various memories (e.g., memory 804, main memory 812, static memory 814, and/or memory of the processors 802) and/or storage unit 816 may store one or more sets of instructions and data structures (e.g., software) embodying or used by any one or more of the methodologies or functions described herein. These instructions (e.g., the instructions 808), when executed by processors 802, cause various operations to implement the disclosed examples.

The instructions 808 may be transmitted or received over the network 820, using a transmission medium, via a network interface device (e.g., a network interface component included in the communication components 840) and using any one of a number of well-known transfer protocols (e.g., hypertext transfer protocol (HTTP)). Similarly, the instructions 808 may be transmitted or received using a transmission medium via the coupling 826 (e.g., a peer-to-peer coupling) to the devices 822.

Although examples have been described, it will be evident that various modifications and changes may be made to these examples without departing from the broader scope of the present disclosure. Accordingly, the specification and drawings are to be regarded in an illustrative rather than a restrictive sense. The accompanying drawings that form a part hereof, show by way of illustration, and not of limitation, specific examples in which the subject matter may be practiced. The examples illustrated are described in sufficient detail to enable those skilled in the art to practice the teachings disclosed herein. Other examples may be utilized and derived therefrom, such that structural and logical substitutions and changes may be made without departing from the scope of this disclosure. This Detailed Description, therefore, is not to be taken in a limiting sense, and the scope of various examples is defined only by the appended claims, along with the full range of equivalents to which such claims are entitled.

Such examples of the inventive subject matter may be referred to herein, individually and/or collectively, by the term “invention” merely for convenience and without intending to voluntarily limit the scope of this application to any single invention or inventive concept if more than one is in fact disclosed. Thus, although specific examples have been illustrated and described herein, it should be appreciated that any arrangement calculated to achieve the same purpose may be substituted for the specific examples shown. This disclosure is intended to cover any and all adaptations or variations of various examples. Combinations of the above examples, and other examples not specifically described herein, will be apparent to those of skill in the art upon reviewing the above description.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single example for the purpose of streamlining the disclosure. This method of disclosure is not to be interpreted as reflecting an intention that the claimed examples require more features than are expressly recited in each claim. Rather, as the following claims reflect, inventive subject matter lies in less than all features of a single disclosed example. Thus the following claims are hereby incorporated into the Detailed Description, with each claim standing on its own as a separate example.

In view of the disclosure above, various examples are set forth below. It should be noted that one or more features of an example, taken in isolation or combination, should be considered within the disclosure of this application.

Example 1. A system comprising: one or more hardware processors; and at least one machine-storage medium for storing instructions that, when executed by the one or more hardware processors, cause the one or more hardware processors to perform operations comprising: selecting an individual item from an inventory associated with an online seller in an online e-commerce platform; obtaining, from a database of the online e-commerce platform, information associated with the individual item; processing the information associated with the individual item by one or more large language models (LLMs) and one or more machine learning models to identify a target item that is associated with the individual item; and generating a recommendation for presentation to the online seller.

Example 2. The system of Example 1, wherein processing the information comprises: generating, using at least partially a set of data stored in the database, a set of knowledge graphs (KGs) by the one or more LLMs; processing the set of KGs and data associated with a plurality of items and the online seller to select the target item; and detecting a condition comprising the individual item being frequently included in transactions associated with a second item of the plurality of items.

Example 3. The system of any one of Examples 1-2, wherein the operations comprise: in response to detecting the condition, generating the set of KGs comprising a leaf category expert KG, a user-item transaction KG, and an item aspect expert KG.

Example 4. The system of any one of Examples 1-3, wherein the operations for generating the leaf category expert KG comprise: identifying an individual category associated with the individual item; generating a prompt with an instruction to identify a plurality of complementary categories in which a set of users are interested in completing transactions for items, wherein the set of users have each previously completed one or more transactions for items in the individual category; and processing the prompt by the one or more LLMs to generate a list of complementary categories.

Example 5. The system of any one of Examples 1-4, wherein the operations comprise: generating the leaf category expert KG comprising unidirectional relationships between nodes representing the individual category and the list of complementary categories.

Example 6. The system of any one of Examples 1-5, wherein the operations for generating the item aspect expert KG comprise: identifying an individual category associated with the individual item; generating a first prompt with a first instruction to identify a set of item aspects transacting users consider in performing transactions for items associated with the individual category; and processing the first prompt and inventory aspect data associated with the plurality of items by the one or more LLMs to generate a list of item aspects.

Example 7. The system of any one of Examples 1-6, wherein the operations comprise: generating a second prompt with a second instruction to process each item aspect of the list of item aspects to identify a set of relevant aspects associated with each item aspect in which transacting users are interested in completing transactions for items, the transacting users comprising a set of users who have previously completed transactions in items in the respective item aspect; and processing the second prompt and the inventory aspect data to generate a list of relevant aspects by the one or more LLMs for each item aspect of the list of item.

Example 8. The system of any one of Examples 1-7, wherein the operations comprise: generating the item aspect expert KG comprising relationships between nodes representing the list of relevant aspects for each item aspect of the list of item aspects.

Example 9. The system of any one of Examples 1-8, wherein the operations for generating the user-item transaction KG comprise: identifying a set of transacting users who previously performed a transaction on the individual item from other users; identifying other items that the set of transacting users performed transactions on within a threshold interval; and generating the user-item transaction KG comprising relationships between nodes representing the individual item and the other items.

Example 10. The system of any one of Examples 1-9, wherein the operations comprise: generating user embedding information by processing item embedding information associated with the plurality of items with items in the inventory associated with the online seller.

Example 11. The system of any one of Examples 1-10, wherein the operations comprise: generating embeddings for each node in the set of KGs based on the item embedding information associated with the plurality of items.

Example 12. The system of any one of Examples 1-11, wherein the operations comprise: processing a first set of nodes in the leaf category expert KG by a path sampling component to generate a first plurality of meta-path instances; processing a second set of nodes in the user-item transaction KG by the path sampling component to generate a second plurality of meta-path instances; and processing a third set of nodes in the item aspect expert KG by the path sampling component to generate a third plurality of meta-path instances.

Example 13. The system of any one of Examples 1-12, wherein each meta-path instance in the first plurality of meta-path instances comprises first, second, third, and fourth nodes connected in sequence, the first node representing a first item associated with a first category represented by the second node in the leaf category expert KG, the third node representing a second category in the leaf category expert KG that is related to the first category, and the fourth node representing a second item associated with the second category.

Example 14. The system of any one of Examples 1-13, wherein each meta-path instance in the second plurality of meta-path instances comprises first, second, third, and fourth nodes connected in sequence, the first node representing a first user who performed a transaction for a third item represented by the second node in the user-item transaction KG, the third node representing a second user who performed a transaction for the third item and who performed a transaction for a fourth item represented by the fourth node.

Example 15. The system of any one of Examples 1-14, wherein each meta-path instance in the third plurality of meta-path instances comprises first, second, third, and fourth nodes connected in sequence, the first node representing a first item associated with a first item aspect represented by the second node in the item aspect expert KG, the third node representing a second item aspect in the item aspect expert KG that is related to the first item aspect, and the fourth node representing a second item associated with the second item aspect.

Example 16. The system of any one of Examples 1-15, wherein the operations comprise: encoding the first plurality of meta-path instances by a path encoding layer of the one or more machine learning models to generate a first path encoding; encoding the second plurality of meta-path instances by the path encoding layer of the one or more machine learning models to generate a second path encoding; encoding the third plurality of meta-path instances by the path encoding layer of the one or more machine learning models to generate a third path encoding; and processing the first path encoding, the second path encoding, and the third path encoding by a self-attention layer of the one or more machine learning models to generate meta-path based context embedding associated with the first path encoding, the second path encoding, and the third path encoding, the self-attention layer trained to weigh importance of different path instances in a same context against each other while capturing dependencies between the path instances.

Example 17. The system of any one of Examples 1-16, wherein the operations comprise: processing the meta-path based context embedding together with the user embedding information by a cross attention layer of the one or more machine learning models to generate context-based user embedding data; and processing the meta-path based context embedding together with the item embedding information by the cross attention layer of the one or more machine learning models to generate context-based item embedding data.

Example 18. The system of any one of Examples 1-17, wherein the operations comprise: combining the context-based user embedding data with the context-based item embedding data to generate a unified representation; processing the unified representation by a multi-layer perceptron (MLP) layer of the one or more machine learning models to generate scores that relate the online seller with a subset of items of the plurality of items; and identifying the target item from the subset of items based on the scores that relate the online seller with the subset of items of the plurality of items.

Example 19. A method comprising: selecting, by one or more hardware processors, an individual item from an inventory associated with an online seller in an online e-commerce platform; obtaining, from a database of the online e-commerce platform, information associated with the individual item; processing the information associated with the individual item by one or more large language models (LLMs) and one or more machine learning models to identify a target item that is associated with the individual item; and generating a recommendation for presentation to the online seller to expand the inventory associated with the online seller to include the target item.

Example 20. A machine-storage medium for storing instructions that, when executed by one or more hardware processors, cause the one or more hardware processors to perform operations comprising: selecting an individual item from an inventory associated with an online seller in an online e-commerce platform; obtaining, from a database of the online e-commerce platform, information associated with the individual item; processing the information associated with the individual item by one or more large language models (LLMs) and one or more machine learning models to identify a target item that is associated with the individual item; and generating a recommendation for presentation to the online seller to expand the inventory associated with the online seller to include the target item.

What is claimed is:

1. A system comprising:
one or more hardware processors; and
at least one machine-storage medium for storing instructions that, when executed by the one or more hardware processors, cause the one or more hardware processors to perform operations comprising:
selecting an individual item from an inventory associated with an online seller in an online e-commerce platform;
obtaining, from a database of the online e-commerce platform, information associated with the individual item;
processing the information associated with the individual item by one or more large language models (LLMs) and one or more machine learning models to identify a target item that is associated with the individual item; and
generating a recommendation for presentation to the online seller.

2. The system of claim 1, wherein processing the information comprises:
generating, using at least partially a set of data stored in the database, a set of knowledge graphs (KGs) by the one or more LLMs;
processing the set of KGs and data associated with a plurality of items and the online seller to select the target item; and
detecting a condition comprising the individual item being frequently included in transactions associated with a second item of the plurality of items.

3. The system of claim 2, wherein the operations comprise:
in response to detecting the condition, generating the set of KGs comprising a leaf category expert KG, a user-item transaction KG, and an item aspect expert KG.

4. The system of claim 3, wherein the operations for generating the leaf category expert KG comprise:
identifying an individual category associated with the individual item;
generating a prompt with an instruction to identify a plurality of complementary categories in which a set of users are interested in completing transactions for items, wherein the set of users have each previously completed one or more transactions for items in the individual category; and
processing the prompt by the one or more LLMs to generate a list of complementary categories.

5. The system of claim 4, wherein the operations comprise:
generating the leaf category expert KG comprising unidirectional relationships between nodes representing the individual category and the list of complementary categories.

6. The system of claim 3, wherein the operations for generating the item aspect expert KG comprise:
identifying an individual category associated with the individual item;
generating a first prompt with a first instruction to identify a set of item aspects transacting users consider in performing transactions for items associated with the individual category; and
processing the first prompt by the one or more LLMs and inventory aspect data associated with the plurality of items to generate a list of item aspects.

7. The system of claim 6, wherein the operations comprise:
generating a second prompt with a second instruction to process each item aspect of the list of item aspects to identify a set of relevant aspects associated with each item aspect in which transacting users are interested in completing transactions for items, the transacting users comprising a set of users who have previously completed transactions in items in the respective item aspect; and
processing the second prompt by the one or more LLMs and the inventory aspect data to generate a list of relevant aspects for each item aspect of the list of item.

8. The system of claim 7, wherein the operations comprise:
generating the item aspect expert KG comprising relationships between nodes representing the list of relevant aspects for each item aspect of the list of item aspects.

9. The system of claim 3, wherein the operations for generating the user-item transaction KG comprise:
identifying a set of transacting users who previously performed a transaction on the individual item from other users;
identifying other items that the set of transacting users performed transactions on within a threshold interval; and
generating the user-item transaction KG comprising relationships between nodes representing the individual item and the other items.

10. The system of claim 3, wherein the operations comprise:
generating user embedding information by processing item embedding information associated with the plurality of items with items in the inventory associated with the online seller.

11. The system of claim 10, wherein the operations comprise:
generating embeddings for each node in the set of KGs based on the item embedding information associated with the plurality of items.

12. The system of claim 11, wherein the operations comprise:
processing a first set of nodes in the leaf category expert KG by a path sampling component to generate a first plurality of meta-path instances;
processing a second set of nodes in the user-item transaction KG by the path sampling component to generate a second plurality of meta-path instances; and
processing a third set of nodes in the item aspect expert KG by the path sampling component to generate a third plurality of meta-path instances.

13. The system of claim 12, wherein each meta-path instance in the first plurality of meta-path instances comprises first, second, third, and fourth nodes connected in sequence, the first node representing a first item associated with a first category represented by the second node in the leaf category expert KG, the third node representing a second category in the leaf category expert KG that is related to the first category, and the fourth node representing a second item associated with the second category.

14. The system of claim 12, wherein each meta-path instance in the second plurality of meta-path instances comprises first, second, third, and fourth nodes connected in sequence, the first node representing a first user who performed a transaction for a third item represented by the second node in the user-item transaction KG, the third node representing a second user who performed a transaction for the third item and who performed a transaction for a fourth item represented by the fourth node.

15. The system of claim 12, wherein each meta-path instance in the third plurality of meta-path instances comprises first, second, third, and fourth nodes connected in sequence, the first node representing a first item associated with a first item aspect represented by the second node in the item aspect expert KG, the third node representing a second item aspect in the item aspect expert KG that is related to the first item aspect, and the fourth node representing a second item associated with the second item aspect.

16. The system of claim 12, wherein the operations comprise:
encoding the first plurality of meta-path instances by a path encoding layer of the one or more machine learning models to generate a first path encoding;
encoding the second plurality of meta-path instances by the path encoding layer of the one or more machine learning models to generate a second path encoding;
encoding the third plurality of meta-path instances by the path encoding layer of the one or more machine learning models to generate a third path encoding; and
processing the first path encoding, the second path encoding, and the third path encoding by a self-attention layer of the one or more machine learning models to generate meta-path based context embedding associated with the first path encoding, the second path encoding, and the third path encoding, the self-attention layer trained to weigh importance of different path instances in a same context against each other while capturing dependencies between the path instances.

17. The system of claim 16, wherein the operations comprise:
processing the meta-path based context embedding together with the user embedding information by a cross attention layer of the one or more machine learning models to generate context-based user embedding data; and
processing the meta-path based context embedding together with the item embedding information by the cross attention layer of the one or more machine learning models to generate context-based item embedding data.

18. The system of claim 17, wherein the operations comprise:
combining the context-based user embedding data with the context-based item embedding data to generate a unified representation;
processing the unified representation by a multi-layer perceptron (MLP) layer of the one or more machine learning models to generate scores that relate the online seller with a subset of items of the plurality of items; and
identifying the target item from the subset of items based on the scores that relate the online seller with the subset of items of the plurality of items.

19. A method comprising:
selecting, by one or more hardware Processors, an individual item from an inventory associated with an online seller in an online e-commerce platform;
obtaining, from a database of the online e-commerce platform, information associated with the individual item;
processing the information associated with the individual item by one or more large language models (LLMs) and one or more machine learning models to identify a target item that is associated with the individual item; and
generating a recommendation for presentation to the online seller to expand the inventory associated with the online seller to include the target item.

20. A machine-storage medium for storing instructions that, when executed by one or more hardware processors, cause the one or more hardware processors to perform operations comprising:
selecting an individual item from an inventory associated with an online seller in an online e-commerce platform;
obtaining, from a database of the online e-commerce platform, information associated with the individual item;
processing the information associated with the individual item by one or more large language models (LLMs) and one or more machine learning models to identify a target item that is associated with the individual item; and
generating a recommendation for presentation to the online seller to expand the inventory associated with the online seller to include the target item.
